(19) United States
(12) Patent Application Publication
(10) Pub. No.: US 2017/0236233 A1
(43) Pub. Date: Aug. 17, 2017

(54) System and Method for Conducting Background Checks Online

(71) Applicant: Mark Shuman, Melbourne, FL (US)

(72) Inventor: Mark Shuman, Melbourne, FL (US)

(21) Appl. No.: 15/436,362

(22) Filed: Feb. 17, 2017

Related U.S. Application Data
(63) Continuation of application No. 62/296,324, filed on Feb. 17, 2016.

(51) Int. Cl. G06Q 50/26; G06F 17/30; G06Q 50/00

(52) U.S. Cl. CPC G06Q 50/265; G06Q 50/01; G06F 17/30867

(57) ABSTRACT

A method for performing and providing to third parties background investigations of individuals comprised of preparing a detailed background report using a plurality of personal identifier data, and generating an edited background report based on the detailed background report wherein the edited background report does not include the plurality of personal identifier data.

### RELATED APPLICATION DATA

This application claims priority to U.S. Provisional Patent Application Ser. No. 62/296,324, filed Feb. 17, 2016, entitled “System and Method for Conducting Background Checks Online,” the contents of which is fully incorporated by reference herein for all purposes.

### BACKGROUND OF THE INVENTION

Field of the Invention

This invention relates to a method for providing a dating candidate who uses online dating services (“Dating Candidate”) with a means of providing other users of online dating services (“Subscriber”) with a detailed background check about the Dating Candidate while at the same time protecting the Dating Candidate's confidential personal information.

Background of the Invention

Law enforcement personnel generally understand that when more information is available about an individual, the more thorough an investigation that can be performed regarding the background of that individual.

Currently, a Subscriber to an online dating service, when making the decision whether to communicate with or to meet a Dating Candidate, is unable, with confidence, to confirm the background history, or even the existence, of a Dating Candidate because of the online dating service's failure to provide sufficient personal information about a Dating Candidate which a Subscriber may submit to existing background investigation companies to ensure that the results of a search of public records regarding a Dating Candidate conducted by such existing background investigation companies are accurate. Instead, a Subscriber desiring to obtain a background check about a Dating Candidate must rely, if at all, only on superficial and unreliable information about the Dating Candidate which was provided by the Dating Candidate (such as the Dating Candidate's first and last names and state of residence) when having a background investigation conducted on a Dating Candidate. This lack of available personal information about a Dating Candidate is because online dating services' procedures which shield the identity and personal information of a Dating Candidate from Subscribers, unless the Dating Candidate voluntarily provides such information in his/her online personal dating profile. Ironically, the voluntary disclosure by a Dating Candidate of personal information is highly discouraged by online dating services because of justifiable safety concerns. So, too, a Dating Candidate usually is reluctant to disclose too much personal information in his/her online personal dating profile.

Even if a Dating Candidate voluntarily discloses his/her first and last names and city of residence to a Subscriber, the accuracy and thoroughness of a background investigation conducted of the Dating Candidate which a Subscriber currently can obtain from existing online background investigation companies are questionable. This is because the extremely limited personal information about the Dating Candidate that the Subscriber is able to provide to the background investigation companies frequently results in the generation of information relating to several, or more, individuals with the same, or similar, names who live in the same city or state as the Dating Candidate whose background the Subscriber is seeking to investigate, thereby causing the background investigation to be of little, if any, use or value to the Subscriber.

A Dating Candidate typically recognizes that a Subscriber might seek to obtain a background investigation about the Dating Candidate before agreeing to meet the Dating Candidate. This creates a problem for the Dating Candidate: while the Dating Candidate wants to ensure that a background investigation about the Dating Candidate not only is accurate, but also, in fact, relates to that Dating Candidate, the Dating Candidate does not wish to disclose to a Subscriber too much personal information which, ordinarily, would enhance the validity of a background investigation of the Dating Candidate performed at the request of the Subscriber. The present invention seeks to solve that problem.

Existing online background investigation services have yet to provide a simple means for a Subscriber to obtain a background investigation of a Dating Candidate to confirm a Dating Candidate's first name, age, marital status, employment, city of residence, online dating site fictitious name, and criminal history, if any, without a Dating Candidate revealing to a Subscriber detailed personal information about the Dating Candidate used by background investigation services to conduct an in-depth and accurate background investigation.

Therefore, it is an object of this invention for a Dating Candidate himself to provide detailed personal information about the Dating Candidate to the background investigation service proposed herein (the “Service Provider”) to be used only by the Service Provider to perform a background investigation regarding the Dating Candidate, without disclosing such detailed personal information to Subscribers, and then providing a subset of the background investigation search results to Subscribers wherein the subset background investigation search results do not reveal confidential personal information about the Dating Candidate, but, rather, reveal sufficient information about the background of a Dating Candidate to assist Subscribers in making the decision whether to meet the Dating Candidate.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

A method for performing background investigations and making the results of those background investigations available to third parties comprised of a home page of the Service Provider's website in which is described the nature of the website and provides an option for a Dating Candidate and an option for a Subscriber. The option for a Dating Candidate leads the Dating Candidate to a “Dating Candidate Input Page”, and the option for a Subscriber leads to a “Subscriber Input Page”. The “Dating Candidate Input Page” consists of personal identifier data input fields and a submission option. The Dating Candidate supplies in the “Dating Candidate Input Page” an identification representation including the Dating Candidate's (1) full name; (2) date of birth; (3) Social Security number; (4) driver's license number and state of issue; (5) current address; (6) recent addresses; (7) marital status; and (8) employment in order that a thorough background investigation of the Dating Candidate may be conducted by the Service Provider, either independently or through third-party providers, which identification representation, as discussed below, is subsequently confirmed by the Service Provider to relate to the Dating Candidate. The identification representation submitted by the Dating Candidate to the Service Provider is detailed personal information which is kept confidential by the Service Provider which does not reveal this detailed personal information to Subscribers.

The Service Provider, or its third-party providers, uses the personal information submitted by the Dating Candidate to generate a Detailed Background Report about the Dating Candidate. The Detailed Background Report is an in-depth background investigation of the Dating Candidate. After confirming with the Dating Candidate, using the method described below, that the Detailed Background Report, in fact, relates to the Dating Candidate, the Service Provider generates from the Detailed Background Report an Edited Background Report. The Edited Background Report provides a subset of information contained in the Detailed Background Report wherein the subset of information does not include the Dating Candidate's detailed personal confidential information. In a preferred embodiment, the Edited Background Report may include the Dating Candidate's first name, city and/or state of residence, age, marital status, occupation, dating site(s) fictitious name(s) and criminal history (preferably limited to offenses of which the Dating Candidate was found guilty, after age 21 but no earlier than, e.g., twenty (20) years before the Detailed Background Report is prepared), of crimes involving domestic abuse, sexual misconduct, assault and battery (with or without a weapon), theft, dishonesty or alcohol (e.g., driving while intoxicated). The fact that the Edited Background Report makes reference to only these types of conduct will be prominently set forth in the Edited Background Report able to be viewed by Subscribers.

The Service Provider then sends the Dating Candidate both the Detailed Background Report and the Edited Background Report. The Dating Candidate then informs the Service Provider of the number of months (preferably not to exceed four (4)) that the Edited Background Report is to be stored on the Service Provider's server and available for access by Subscribers. In a preferred embodiment, the Edited Background Report is assigned a unique Edited Background Report identification number (the “Identification Number”) associated with the Dating Candidate's name. The Edited Background Report is the only background investigation result that is made available to Subscribers. Thus, a Subscriber may learn background information about a Dating Candidate, where the Dating Candidate has ordered the Detailed Background Report and the Edited Background Report, but the Subscriber cannot learn of either (a) the confidential personal information provided by the Dating Candidate and used by the Service Provider or its third-party providers to prepare the Detailed Background Report of the Dating Candidate, or (b) the Detailed Background Report.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It also should be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a flow chart of the Dating Candidate's background investigation preparation process.

FIG. 2 is a flow chart of the Subscriber's review of the Dating Candidate's Edited Background Report.

FIG. 3 is a flow chart of the Service Provider's background investigation preparation process.

FIG. 4 is a representative view of the Dating Candidate's input page.

FIG. 5 is a representative view of the Subscriber input page.

Similar reference characters refer to similar parts throughout the several views of the drawings.

### DETAILED DESCRIPTION OF THE PREFERRED EMBODIMENT

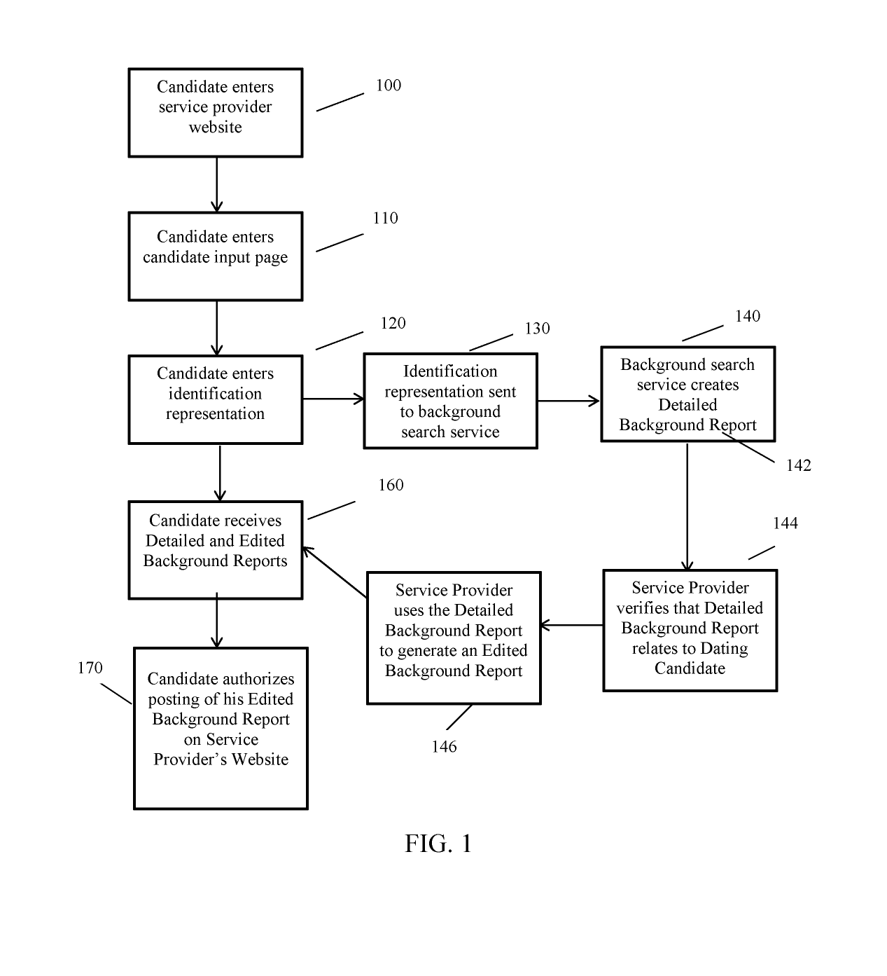

FIG. 1 shows a flow chart from the Dating Candidate's perspective of the background investigation preparation process. First, the Dating Candidate enters the Service Provider's website homepage 100. Then, the Dating Candidate chooses the “Dating Candidate” option and enters the Dating Candidate Input Page 110. On the Dating Candidate Input Page, the Dating Candidate will enter an identification representation 120. This identification representation will include various pieces of personal information to be used to perform a background investigation, such as full name, social security number, date of birth, driver's license number and state of issue, current address, recent addresses, marital status and employment. Importantly, this identification representation will include confidential personal information to be used to generate a Detailed Background Report. Once the Dating Candidate enters this confidential personal information as an identification representation and submits the information to the Service Provider, the Service Provider, for a fee, will conduct (or have conducted) a background investigation of the Dating Candidate 130.

The background investigation can be conducted either by an independent background investigation company or by the Service Provider itself. Whoever is performing the background investigation 140 creates a Detailed Background Report 142, information from which is utilized by the Service Provider, before the Detailed Background Report is furnished to the Dating Candidate, to confirm that the information in the Detailed Background Report, in fact, relates to the Dating Candidate 144. Upon confirmation that the Detailed Background Report, in fact, relates to the Dating Candidate, The Service Provider then uses the Detailed Background Report to generate an Edited Background Report 146. The Edited Background Report removes certain confidential personal identification information from the Detailed Background Report but includes the Dating Candidate's first name, city and/or state of residence, age, marital status, occupation, dating site(s) fictitious name(s) and criminal history limited to offenses of which the Dating Candidate was found guilty (preferably after age 21, but no earlier than, e.g., twenty (20) years before the preparation of the Detailed Background Report, of crimes involving domestic abuse, sexual misconduct, assault and battery (with or without a weapon), theft, dishonesty or alcohol (e.g., driving while intoxicated)). The fact that the Edited Background Report makes reference to only these types of conduct will be prominently set forth in the Edited Background Report viewed by Subscribers. After verification by the Dating Candidate that the Detailed Background Report relates to the Dating Candidate 144, the Dating Candidate plays no part in the preparation of the Edited Background Report.

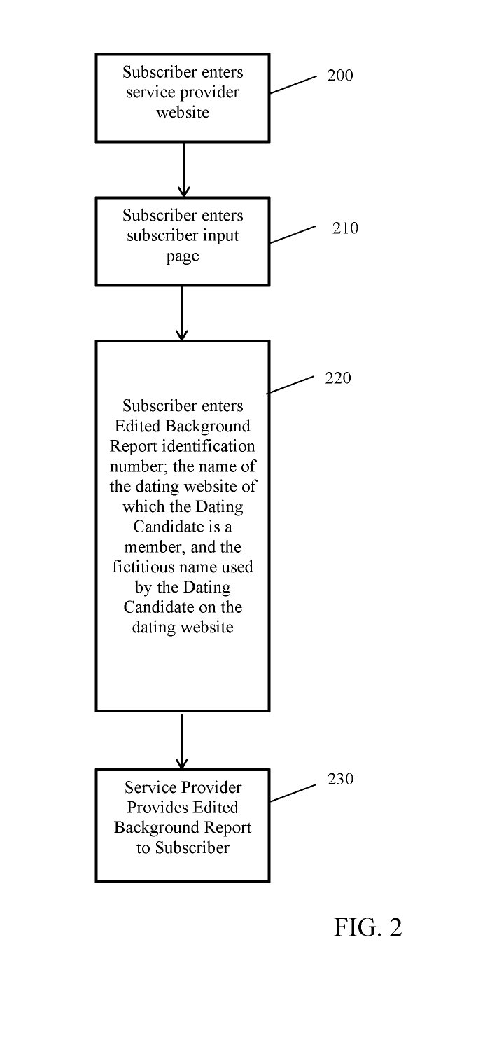

FIG. 2 shows a flow chart from the Subscriber's perspective of the Subscriber's review of the Dating Candidate's Edited Background Report. First the Subscriber enters the Service Provider's website home page 200. Then, the Subscriber chooses the “Subscriber” option and enters the Subscriber Input page 210. The Subscriber then enters (1) the Edited Background Report Identification Number assigned to the Dating Candidate's Edited Background Report by the Service Provider which was included by the Dating Candidate in his dating website profile 220; (2) the name of the dating website of which the Dating Candidate is a member; and (3) the Dating Candidate's fictitious name used by the Dating Candidate in his dating website profile. The only background report to which the Subscriber has access is the Edited Background Report 230.

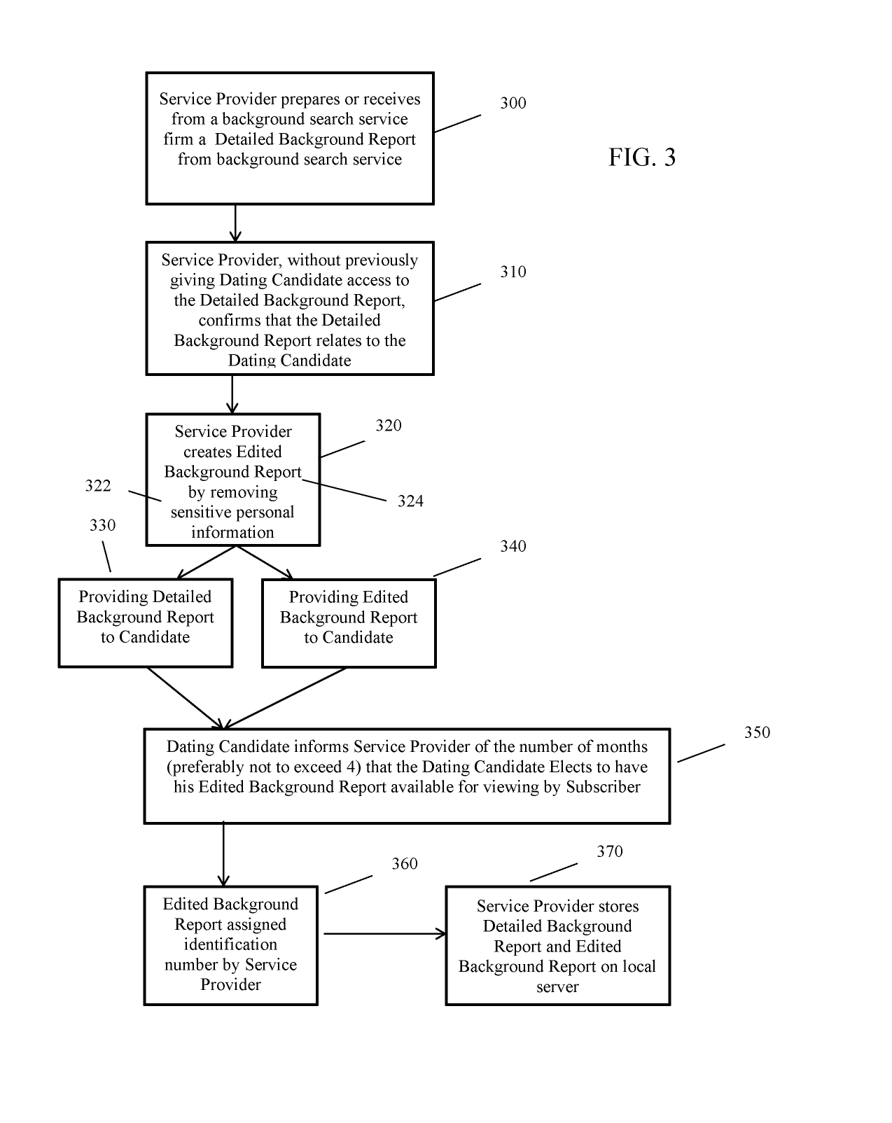

FIG. 3 shows a flow chart of the background investigation process from the Service Provider's perspective. For a fee, the Service Provider first prepares or obtains a Detailed Background Report 142 about a Dating Candidate utilizing the identification representation provided by the Dating Candidate 300. This Detailed Background Report 142 may be obtained from an independent background investigation service or, alternatively, the Service Provider itself can perform the background investigation and prepare the Detailed Background Report 142. Once a background investigation has been performed and the Detailed Background Report 142 prepared, the identity of the Dating Candidate who requested the Detailed Background Report 142 can be confirmed by the Service Provider in a number of ways 310. The preferred method is through the widely-utilized online method of, before the Detailed Background Report is shown to the Dating Candidate, asking the Dating Candidate several personal questions formulated using information disclosed in the Detailed Background Report 142. Once the Dating Candidate's identity is thus confirmed by the Service Provider, the Service Provider, creates an Edited Background Report 320. The Edited Background Report 320 contains information about the Dating Candidate, such as the Dating Candidate's first name, city and/or state of residence, age, marital status, occupation, dating site(s) fictitious name(s) and criminal history limited to offenses of which the Dating Candidate was found guilty, preferably after age 21, but no earlier than, e.g., twenty (20) years before the preparation of the Detailed Background Report, of crimes involving domestic abuse, sexual misconduct, assault and battery (with or without a weapon), theft dishonesty or alcohol (e.g., driving while intoxicated). The fact that the Edited Background Report 320 makes reference to only these types of conduct will be prominently set forth in the Edited Background Report viewed by Subscribers. The Edited Background Report 320 does not include the Dating Candidate's confidential personal information which the Dating Candidate initially provided to the Service Provider or certain criminal offenses. The Detailed Background Report 142 and Edited Background Report 146 are then provided to the Dating Candidate simultaneously at steps 330 and 340. At this time, the Service Provider asks the Dating Candidate for how many months (not to exceed four (4)), for a fee, the Dating Candidate wishes his Edited Background Report to be available on the Service Provider's website for viewing by Subscribers. Once the Dating Candidate chooses the length of time the Dating Candidate's Edited Background Report to be available on the Service Provider's website, the Service Provider assigns to the Edited Background Report 324 a unique Identification Number associated with the Candidate 360 and informs the Dating Candidate of the Identification Number. The Detailed Background Report and Edited Background Report 324 are then stored on the Service Provider's server 370.

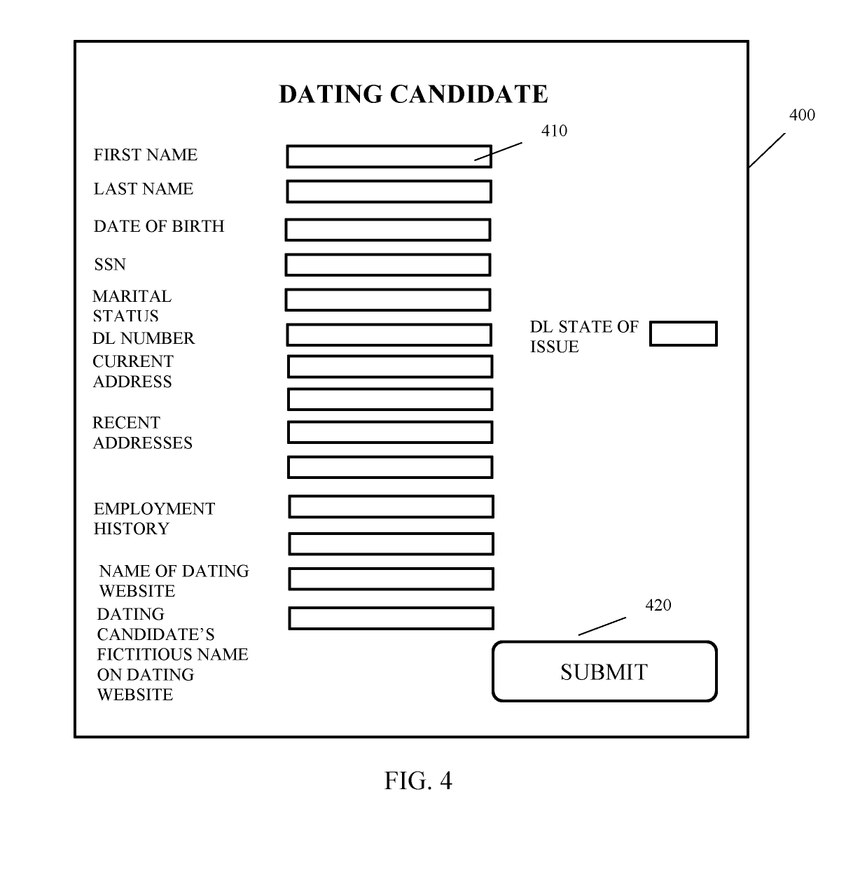

FIG. 4 is a representative view of the Dating Candidate input page 400. The Dating Candidate input page 400 has a plurality of personal identifier input fields 410. These fields generally request personal information about the Dating Candidate that will assist with the conduct of a correct and thorough background investigation, such as first and last names, date of birth, social security number, marital status, driver's license number and state of issue, current address, past/recent addresses, employment history, and other personal identifiers. Because Dating Candidate's frequently participate in the programs of several different online dating websites, a Dating Candidate also will be asked to identify each online dating website of which he is a member and the fictitious name used by the Dating Candidate on each such website. Once all of these fields are filled in, a Dating Candidate can then use the submission option 420 to submit to the Service Provider the information for the background investigation process described above, for a fee, to commence.

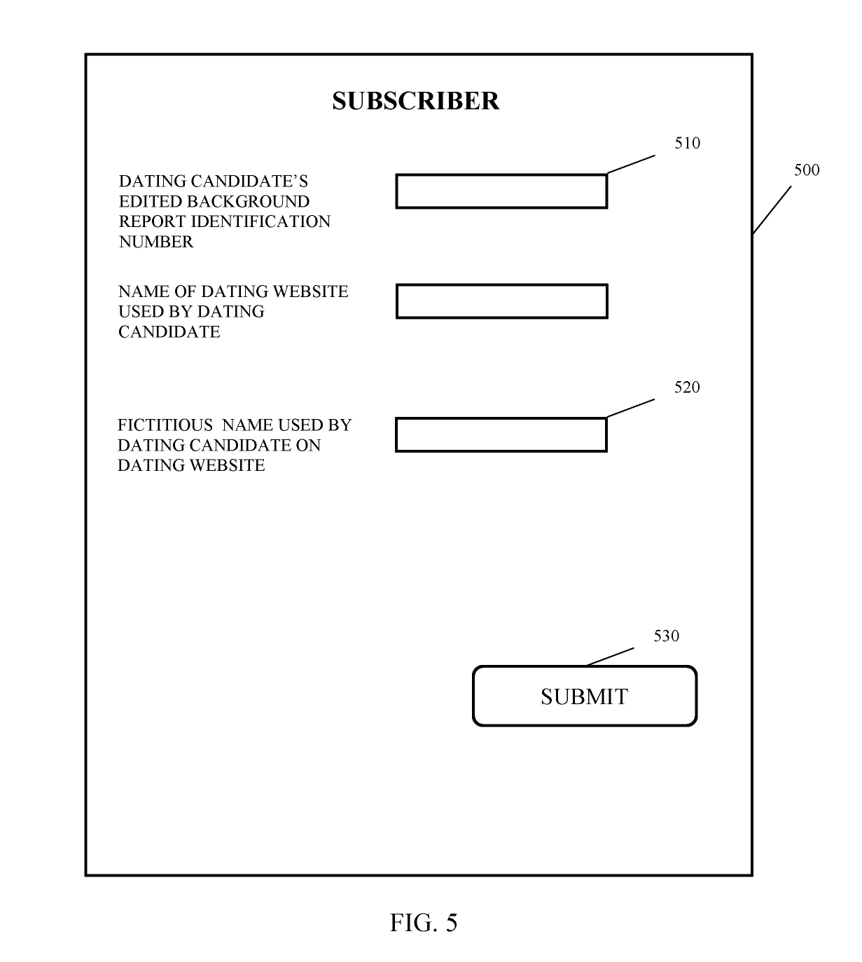

FIG. 5 is a representative view of the Subscriber input page 500. The Subscriber input page has (1) an Edited Background Report Identification Number field 510, (2) a Dating Candidate dating website field and (3) a dating website fictitious name field, to be utilized by the Service Provider to identify the Dating Candidate's Edited Background Report which a Subscriber seeks to view. As with the Dating Candidate Input Page, once the Edited Background Report Identification Number field 510, dating website field and dating website fictitious name field 520 are filled in by the Subscriber, the Subscriber can then, for a fee, use the submission option 530 to receive from the Service Provider online access to the Edited Background Report 324 of the corresponding Dating Candidate. Access to a Dating Candidate's Edited Background Report will be granted only to a Subscriber who can supply (1) a Dating Candidate's Identification Number, (2) the name of the dating site through which the Subscriber had contact with the Dating Candidate and (3) the fictitious name used by the Dating Candidate on the dating website. The identity of Subscribers who view a Dating Candidate's Edited Background Report is never disclosed to the Dating Candidate.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for performing a background check comprising:
collecting a plurality of personal identifier data from a candidate, wherein the plurality of personal identifier data comprises a first name, a last name, a date of birth, a social security number, a marital status, a driver's license number, a driver's license issuing state, an address, a name of a dating web site, and a dating web site fictitious name;
storing the plurality of personal identifier data in a first database;
preparing a detailed background report of the candidate using the plurality of personal identifier data;
confirming with the candidate that the detailed background check relates to the candidate without providing the detailed background report to the candidate;
preparing an edited background report of the candidate based on the detailed background report, wherein the edited background report comprises the candidates first name, city, state of residence, age, marital status, occupation, dating site fictitious name, and criminal history, wherein the edited background report does not include the plurality of personal identifier data from the candidate;
providing the detailed background report and edited background report to the candidate;
storing in a database the detailed background report, the edited background report, a unique identifier, and a time period during which the edited background report is to be active;
retrieving the edited background report from the database upon a request from a subscriber, wherein the request comprises a unique identifier, a dating site fictitious name, and an identification of a dating site, wherein the edited background report is only retrieved if the request to retrieve it falls within the time period stored in the database during which the edited report is to be active.

2. A method for performing background checks comprising:
collecting personal identifier data from a first user;
preparing a first background report of the first user using the personal identifier data;
storing the first background report in a database;
preparing a second background report of the first user using the first background report wherein the second background report does not contain the personal identifier data;
mapping the second background report to a unique identifier;
providing the second background report to a second user in response to an inquiry using the unique identifier, wherein the second user is not provided access to the first background report.

3. The method of claim 2 wherein the personal identifier data comprises a first name, a last name, a date of birth, a social security number, a marital status, a driver's license number, a driver's license issuing state, an address, a name of a dating website, and a dating website fictitious name.

4. The method of claim 2 wherein preparing a first background report comprises communicating with a third-party via a computer network.

5. The method of claim 2 further comprising:
confirming with the first user that the first background report relates to the first user without providing the first background report to the first user.

6. The method of claim 5 wherein confirming comprises requiring the first user to answer a plurality of personal questions formulated using information disclosed in the first background report.

7. The method of claim 2 wherein mapping the second background report further comprises storing a time period during which the second background report is to be active.
